(19) United States
(12) Patent Application Publication
(10) Pub. No.: US 2024/0359684 A1
(43) Pub. Date: Oct. 31, 2024

(54) APPARATUS AND METHOD FOR CONTROLLING A VEHICLE

(71) Applicants: HYUNDAI MOTOR COMPANY, Seoul (KR); KIA CORPORATION, Seoul (KR)

(72) Inventor: Il Hwan Kim, Hwaseong-si (KR)

(73) Assignees: HYUNDAI MOTOR COMPANY, Seoul (KR); KIA CORPORATION, Seoul (KR)

(21) Appl. No.: 18/520,075

(22) Filed: Nov. 27, 2023

(30) Foreign Application Priority Data
Apr. 27, 2023 (KR) 10-2023-0055557

(51) Int. Cl. B60W 30/09; B60W 30/095; B60W 30/12

(52) U.S. Cl. CPC B60W 30/09; B60W 30/0953; B60W 30/0956; B60W 30/12; B60W 2420/54; B60W 2552/53; B60W 2554/804

(57) ABSTRACT

An apparatus for controlling a vehicle includes a sensor to acquire a sound of another vehicle. The apparatus also includes a position acquiring device to acquire a moving path and an expected moving path of a host vehicle. The apparatus further includes one or more processors and memory storing instructions that, when executed by the one or more processors, cause the one or more processors to determine a driving state of the other vehicle based on at least one of the sound of the other vehicle, the moving path, or the expected moving path, or any combination thereof, determine a moving path of the other vehicle based on a driving state of the other vehicle, and control the host vehicle to avoid the moving path of the other vehicle.

### CROSS-REFERENCE TO RELATED APPLICATION

This application claims the benefit of and priority to Korean Patent Application No. 10-2023-0055557, filed in the Korean Intellectual Property Office on Apr. 27, 2023, the entire contents of which are incorporated herein by reference.

### TECHNICAL FIELD

The present disclosure relates to an apparatus and a method for controlling a vehicle.

### BACKGROUND

Automated Lane Keeping System (ALKS) may control a steering wheel such that a vehicle maintains a lane on which the vehicle is currently driving. ALKS may output a warning sound when the vehicle leaves the driving lane.

When the automated lane keeping function is activated, the vehicle is driven while maintaining a lane (driving lane) on which the vehicle is driving. However, the autonomous driving law allows temporary lane departure from the driving lane to provide a passage for an emergency vehicle or a regulation vehicle.

Recently, technology has been developed to collect a sound, and determine a source area of the sound to determine the position of the emergency vehicle or the regulation vehicle.

The statements in this section merely provide background information related to the present disclosure and may not constitute prior art.

### SUMMARY

Accordingly, a technology is desired to determine the position of an emergency vehicle or a regulation vehicle by using the sound when the automated lane keeping function is activated, and to provide a moving passage for the emergency vehicle or the regulation vehicle. The present disclosure has been made to solve the above-mentioned problems occurring in the prior art while advantages achieved by the prior art are maintained intact.

An aspect of the present disclosure provides an apparatus and a method for controlling a host vehicle capable of effectively using an automated lane keeping function by quickly determining the position of an emergency vehicle using a sound output from the emergency vehicle and a driving path (or expected driving path) of the host vehicle.

Another aspect of the present disclosure provides an apparatus and a method for controlling a host vehicle capable of determining the relationship between a moving path of an emergency vehicle and a moving path of a host vehicle based on the position of an emergency vehicle determined using a sound output from the emergency vehicle and a driving path (or expected driving path) of the host vehicle.

Another aspect of the present disclosure provides an apparatus and a method for controlling a vehicle capable of filtering unnecessary information when generating a moving passage for an emergency vehicle based on a moving path of a host vehicle and a moving path of the emergency vehicle.

Another aspect of the present disclosure provides an apparatus and a method for controlling a host vehicle capable of easily forming a moving path for an emergency vehicle by allowing lane departure in advance, as the moving path of the emergency vehicle is determined using a sound output from the emergency vehicle and a driving path (or expected driving path) of the host vehicle.

The technical problems to be solved by the present disclosure are not limited to the aforementioned problems. Other technical problems not mentioned herein should be clearly understood from the following description by those having ordinary skill in the art to which the present disclosure pertains.

According to an aspect of the present disclosure, an apparatus for controlling a host vehicle is provided. The apparatus may include a sensor configured to acquire a sound of another vehicle. The apparatus may also include a position acquiring device configured to acquire a moving path and an expected moving path of the host vehicle. The apparatus may further include one or more processors and memory storing instructions that, when executed by the one or more processors, cause the one or more processors to perform operations. Operations include determining a driving state of the other vehicle based on at least one of the sound of the other vehicle, the moving path, or the expected moving path, or any combination thereof. The operations also include determining a moving path of the other vehicle based on a driving state of the other vehicle. The operations additionally include controlling the host vehicle to avoid the moving path of the other vehicle.

According to an embodiment, the sensor may include a first sensor provided on a left side of a front portion of the host vehicle, a second sensor provided on a right side of the front portion of the host vehicle, a third sensor provided on a left side of a rear portion of the host vehicle, and a fourth sensor provided on a right side of the rear portion of the host vehicle.

According to an embodiment, the one or more processors may determine that the other vehicle is driving in back of the host vehicle when a time for the sound to reach at least one of the first sensor, the second sensor, or any combination thereof exceeds a time for the sound to reach at least one of the third sensor, the fourth sensor, or any combination thereof.

According to an embodiment, the one or more processors may determine that the other vehicle is driving on a lane the same as a lane on which the host vehicle is driving when i) a difference between a time for the sound to reach the first sensor and a time for the sound to reach the second sensor is less than or equal to a first specific value and ii) a difference between a time for the sound to reach the third sensor and a time for the sound to reach the fourth sensor is less than or equal to the first specific value.

According to an embodiment, the one or more processors may determine that the other vehicle is driving on a lane different from a lane on which the host vehicle is driving when i) the difference between the time for the sound to reach the first sensor and the time for the sound to reach the second sensor exceeds the first specific value and ii) the difference between the time for the sound to reach the third sensor and the time for the sound to reach the fourth sensor exceeds the first specific value.

According to an embodiment, the one or more processors may determine that the other vehicle is driving while approaching the host vehicle when i) a frequency of a sound, which is acquired by at least one of the first sensor, the second sensor, the third sensor, or the fourth sensor, or any combination thereof. is increased in strength and ii) a wavelength of the sound is decreased.

According to an embodiment, the one or more processors may determine that determination of a driving state of the other vehicle has failed when failing to sense at least one of a time for the sound to reach at least one of the first sensor, the second sensor, the third sensor, the fourth sensor, or any combination thereof, a variation of the frequency of the sound, a variation of a wavelength of the sound, or any combination thereof.

According to an embodiment, the one or more processors may determine the driving state of the other vehicle based on at least one of the expected moving path of the host vehicle, the moving path of the host vehicle, or any combination thereof, and a moving path of the sound, wherein the moving path of the sound is formed based on the sound, when it is determined that the determination of the driving state of the other vehicle has failed.

According to an embodiment, the one or more processors may determine whether the moving path of the host vehicle is the same as the moving path of the sound when it is determined that the other vehicle is driving in back of the host vehicle.

According to an embodiment, the one or more processors may determine that the other vehicle is driving while approaching the host vehicle when it is determined that the moving path of the host vehicle is the same as the moving path of the sound.

According to an embodiment, the one or more processors may determine whether the moving path of the host vehicle is opposite to the moving path of the sound when it is determined that the other vehicle is not driving in back of the host vehicle.

According to an embodiment, the one or more processors may determine whether relative speed of the other vehicle is greater than or equal to a threshold speed when it is determined that the moving path of the host vehicle is opposite to the moving path of the sound.

According to an embodiment, the one or more processors may determine that the other vehicle is driving on a driving lane facing a direction opposite to a driving direction of the host vehicle when the relative speed of the other vehicle is greater than or equal to the threshold speed.

According to an embodiment, the processor may determine that the host vehicle is driving while approaching the other vehicle in back of the other vehicle when it is determined that the relative speed of the other vehicle as not greater than or equal to the threshold speed.

According to an embodiment, the one or more processors may control driving of the host vehicle to form a moving passage for moving the other vehicle, based on the driving state of the other vehicle, by activating a driving assist function of the host vehicle.

According to an embodiment, the other vehicle may comprise an emergency vehicle.

According to another aspect of the present disclosure, a method for controlling a host vehicle is provided. The method may include acquiring a sound of another vehicle. The method may also include acquiring a moving path and an expected moving path of the host vehicle. The method may additionally include determining a driving state of the other vehicle based on at least one of the sound of the other vehicle, the moving path, or the expected moving path, or any combination thereof. The method may further include determining the moving path of the other vehicle based on the driving state of the other vehicle. The method may further still include controlling the host vehicle to avoid the moving path of the other vehicle.

According to an embodiment, the method may further include controlling driving of the host vehicle to form a moving passage for moving the other vehicle, based on a driving state of the other vehicle, by activating a driving assist function of the host vehicle.

According to an embodiment, the other vehicle may comprise an emergency vehicle.

### BRIEF DESCRIPTION OF THE DRAWINGS

The above and other objects, features and advantages of the present disclosure should be more apparent from the following detailed description taken in conjunction with the accompanying drawings, in which:

FIG. 1 is a block diagram illustrating a configuration of an apparatus for controlling a vehicle, according to an embodiment of the present disclosure;

FIGS. 2A, 2B and 2C are views schematically illustrating an operation of determining a moving path of a sound, according to an embodiment of the present disclosure;

FIG. 3 is a view schematically illustrating a manner of estimating a moving direction of a sound, according to an embodiment of the present disclosure;

FIGS. 4 and 5 are views schematically illustrating a manner of determining a driving state of an emergency vehicle, according to an embodiment of the present disclosure;

FIGS. 6-10 are views schematically illustrating a manner of determining a driving state of an emergency vehicle, according to another embodiment of the present disclosure;

FIGS. 11 and 12 are flowcharts illustrating a method for controlling a vehicle, according to an embodiment of the present disclosure; and

FIG. 13 is a view illustrating a configuration of a computing system, according to an embodiment of the present disclosure.

### DETAILED DESCRIPTION

Hereinafter, embodiments of the present disclosure are described in detail with reference to accompanying drawings. In the accompanying drawings, identical or equivalent components are designated by the identical numerals even where the components are displayed on different drawings. In addition, in the following description, a detailed description of well-known features or functions has been omitted where the gist of the present disclosure may have been obscured thereby.

In describing elements of embodiments of the present disclosure, the terms first, second, A, B, (a), (b), and the like may be used herein. These terms are only used to distinguish one element from another element. The terms do not limit the nature, sequence, or order of the constituent elements. Furthermore, unless otherwise defined, all terms including technical and scientific terms used herein should be interpreted as is customary in the art to which this disclosure pertains. It should be understood that terms used herein should be interpreted as having a meaning that is consistent with their meaning in the context of this disclosure and the relevant art. The terms should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

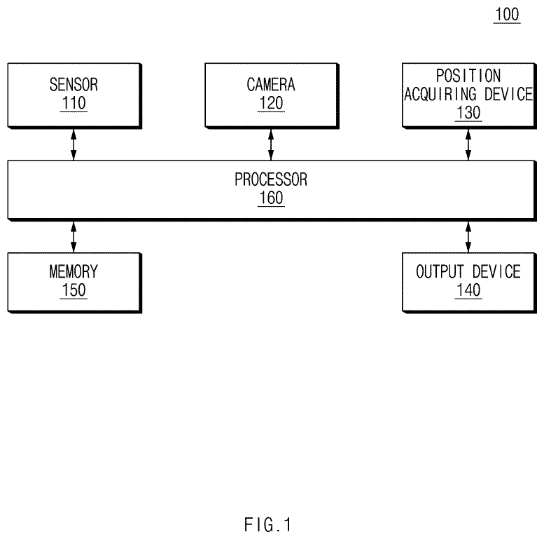

FIG. 1 is a block diagram illustrating components of an apparatus for controlling a vehicle, according to an embodiment of the present disclosure.

As illustrated in FIG. 1, an apparatus 100 for controlling a vehicle according to an embodiment of the present disclosure may include a sensor 110, a camera 120, a position acquiring device 130, an output device 140, a memory 150, and a processor 160. The apparatus 100 may control the driving of a vehicle in which an Automated Lane Keeping System (ALKS) is utilized.

The sensor 110 may acquire a sound of another vehicle. According to an embodiment, the other vehicle may be an emergency vehicle. According to an embodiment, the sensor 110 may include a first sensor provided on a left side of a front portion of the vehicle, a second sensor provided on a right side of the front portion of the vehicle, a third sensor provided on a left side of a rear portion of the vehicle, and a fourth sensor provided on a right side of the rear portion of the vehicle. The sensor 110 may include a microphone. In addition, the sensor 110 may sense an object in the vicinity of the vehicle, for example, a preceding vehicle driving in front of the vehicle, a road, a stationary object including a structure installed around the road, or a vehicle approaching from an opposite lane. In addition, the sensor 110 may sense a lane mark on the road or a signal reflected from the ground surface of the road to acquire data including information on the ground surface of the road or information on a lane of the road. According to an embodiment, the sensor 110 may include a radar or a light detection and ranging (Lidar).

The camera 120 may acquire an image of an object in the vicinity of the vehicle, for example, the preceding vehicle driving in front of the vehicle, the road, the stationary object including a structure installed around the road, or a vehicle approaching from the opposite lane. In addition, the camera 120 may acquire a ground surface image or a lane image of the road by photographing the lane mark of the road or the ground surface of the road. According to an embodiment, the camera 120 may include a front camera, a left camera, a right camera, and a rear camera.

The position acquiring device 130 may be equipped with a global positioning system (GPS) receiver to acquire the information on the position of the vehicle. The position acquiring device 130 may perform map-matching between the position of the vehicle to previously stored map data to provide a map image of a certain area based on the position of the vehicle. The position acquiring device 130 may provide a path from a current position to a destination set by the driver. According to an embodiment, the position acquiring device 130 may match the position of the vehicle based on an ADAS-based high definition map for ensuring a safe operation of the Advanced Driver Assistance System including an Automated Lane Keeping System (ALKS). The position acquiring device 130 may provide a moving path of the vehicle or an expected moving path to the destination based on the ADAS-based precise map of the vehicle. The moving path and/or the expected moving path may be output by the output device 140.

The output device 140 may output the determination result of the processor 160. According to an embodiment, the output device 140 may output the driving state of the emergency vehicle determined by the processor 160. The driving state of the emergency vehicle may include the position of the emergency vehicle and the moving path of the emergency vehicle. The output device 140 may output control information corresponding to a lane change of the host vehicle when the lane change of the host vehicle is required to form a moving path for the emergency vehicle based on the determination result of the processor 160. For example, the control information corresponding to the lane change may include the moving path for lane change and a speed for the lane change. In addition, the output device 140 may output control information corresponding to lane keeping when the lane change of the host vehicle is not required to form a moving path for the emergency vehicle based on the determination result of the processor 160. The output device 140 may be implemented using at least one of a display device, a speaker, or any combination thereof.

The memory 150 may store at least one algorithm to compute or execute various instructions for the operation of the apparatus 100 for controlling the vehicle according to an embodiment of the present disclosure. The memory 150 may include at least one storage medium comprising at least one of a flash memory, a hard disc, a memory card, a Read Only Memory (ROM), a Random Access Memory (RAM), an Electrically Erasable and Programmable ROM (EEPROM), a Programmable ROM (PROM), a magnetic memory, a magnetic disc, an optical disc, and/or the like.

According to an embodiment, the memory 150 may store the ADAS-based precision map for ensuring the safe operation of the Advanced Driver Assistance System. According to an embodiment, the ADAS-based precise map may include information on the position, segment, stub, profile short, profile long, and meta-data of the vehicle.

The processor 160 may be implemented by various processing devices, such as a microprocessor embedded therein with a semiconductor chip to operate or execute various instructions. The processor 160 may control the overall operation of the apparatus 100 for determining the position of the vehicle, according to an embodiment of the present disclosure. The processor 160 may be electrically connected to the sensor 110, the camera 120, the position acquiring device 130, the output device 140, and the memory 150 through a cable and/or various circuits configured to transmit an electrical signal including a control command. The processor 160 may transmit or receive the electrical signal including the control command through various wireless communication network, such as a control area network (CAN).

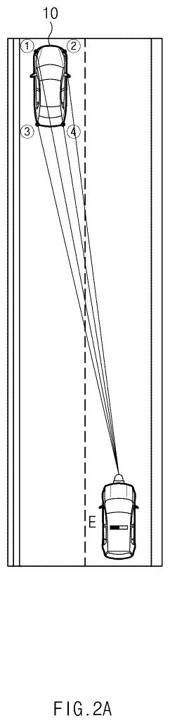

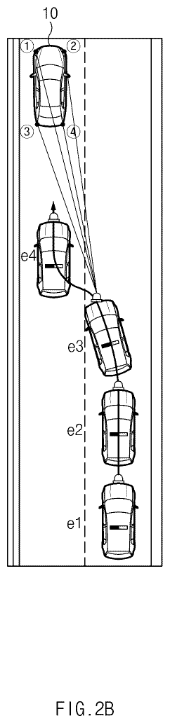

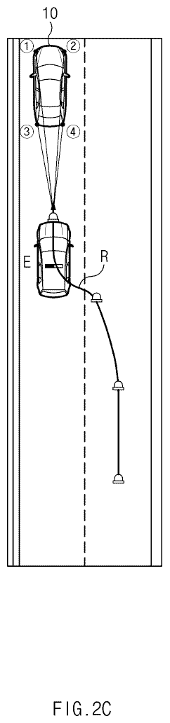

The processor 160 may acquire a sound of the other vehicle, and may generate a moving path of the sound based on the acquired sound. The other vehicle may include an emergency vehicle. The moving path of the sound may indicate the moving path of the emergency vehicle. According to an embodiment, the emergency vehicle may include a vehicle driven according to the provisions of the law for emergency work prescribed by the law. The emergency vehicle may be equipped with a device that generates a siren sound ranging from 90 dB to 120 dB at a position of 30 m from the front portion of the vehicle. The emergency vehicle may also include a warning lamp including a yellow, red, or green blinker. In an embodiment, the emergency vehicle may be equipped with a siren that generates a specific frequency depending on the type of the emergency vehicle. For example, an ambulance may generate a siren having the frequency ranging from 610 Hz to 690 Hz, and a fire truck and a police vehicle may generate a siren having the frequency ranging from 300 Hz to 750 Hz. The emergency vehicle may include an ambulance, a fire truck, a police vehicle, a blood supply vehicle, or a vehicle prescribed by Presidential Decree. The emergency vehicle may drive with a warning light or a siren sound when performing emergency services prescribed by statutes. According to the law, a general vehicle shall yield the course of the general vehicle such that that emergency vehicle may pass first when the emergency vehicle is driving for emergency services prescribed by the statutes. The details thereof are described below with reference to FIGS. 2A, 2B and 2C.

FIGS. 2A, 2B and 2C are views schematically illustrating an operation of determining a moving path of a sound, according to an embodiment of the present disclosure.

As illustrated in FIG. 2A, the processor 160 may acquire (e.g., collect) the time, the wavelength, and the frequency required for the sound of an emergency vehicle E to reach a first sensor ‘\textcircled{1}’, a second sensor ‘\textcircled{2}’, a third sensor ‘\textcircled{3}’, and a fourth sensor ‘\textcircled{4}’ of a host vehicle 10.

As illustrated in FIG. 2B, the processor 160 may determine points ‘e1’, ‘e2’, ‘e3’, and ‘e4’ at which the sound of the emergency vehicle E is generated by consecutively acquiring (collecting) the sound in a specific period. In an embodiment, the processor 160 may determine points ‘e1’, ‘e2’, ‘e3’, and ‘e4’ using a well-known technology based on a characteristic that the time, the wavelength, and the frequency of the sound have values that vary depending on the position of a sound source when the sound reaches the host vehicle 10.

As illustrated in FIG. 2C, the processor 160 may generate a moving path ‘R’ of the sound by linking the points at which the sound of the emergency vehicle are generated to each other.

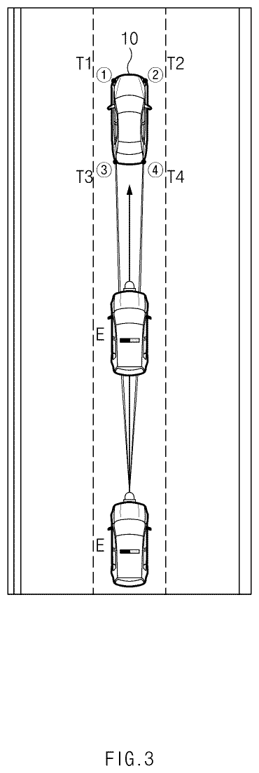

FIG. 3 is a view schematically illustrating a manner of estimating a moving direction of a sound, according to an embodiment of the present disclosure.

As illustrated in FIG. 3, the processor 160 may designate, as ‘T1’, ‘T2’, ‘T3’, and ‘T4’, a time for the sound of the emergency vehicle E to reach the first sensor ‘\textcircled{1}’ of the host vehicle 10, a time for the sound of the emergency vehicle E to reach the second sensor ‘\textcircled{2}’ of the host vehicle 10, a time for the sound of the emergency vehicle E to reach the third sensor ‘\textcircled{3}’ of the host vehicle 10, and a time for the sound of the emergency vehicle E to reach the fourth sensor ‘\textcircled{4}’ of the host vehicle 10, respectively.

The processor 160 may determine that the emergency vehicle is driving behind the host vehicle when the time for the sound of the emergency vehicle E to reach at least one of the first sensor ‘\textcircled{1}’, the second sensor ‘\textcircled{2}’, or any combination thereof exceeds the time for the sound of the emergency vehicle E to reach at least one of the third sensor ‘\textcircled{3}’, the fourth sensor ‘\textcircled{4}’, or any combination thereof.

The processor 160 may determine that the emergency vehicle is driving in front of the host vehicle when the time for the sound of the emergency vehicle E to reach at least one of the first sensor ‘\textcircled{1}’, the second sensor ‘\textcircled{2}’, or a combination thereof does not exceed the time for the sound of the emergency vehicle E to reach at least one of the third sensor ‘\textcircled{3}’, the fourth sensor ‘\textcircled{4}’, or any combination thereof.

The processor may determine that the emergency vehicle is approaching the host vehicle when the strength of the frequency of the sound acquired by at least one of the first sensor ‘\textcircled{1}’, the second sensor ‘\textcircled{2}’, the third sensor ‘\textcircled{3}’, the fourth sensor ‘\textcircled{4}’, or any combination thereof is increased and the wavelength of the sound is decreased.

The processor 160 may determine that the emergency vehicle is driving away from the host vehicle 10 when the strength of the frequency of the sound acquired by at least one of the first sensor ‘\textcircled{1}’, the second sensor ‘\textcircled{2}’, the third sensor ‘\textcircled{3}’, the fourth sensor 4′, or any combination thereof is decreased, and when the wavelength of the sound is increased.

The processor 160 may determine that the emergency vehicle is approaching the host vehicle 10 from the back of the host vehicle 10 when the time for the sound of the emergency vehicle E to reach at least one of the first sensor ‘\textcircled{1}’, the second sensor ‘\textcircled{2}’, or any combination thereof exceeds the time for the sound of the emergency vehicle E to reach at least one of the third sensor ‘\textcircled{3}’, the fourth sensor ‘\textcircled{4}’, or any combination thereof, when the strength of the frequency of the sound acquired by at least one of the first sensor ‘\textcircled{1}’, the second sensor ‘\textcircled{2}’, the third sensor ‘\textcircled{3}’, the fourth sensor ‘\textcircled{4}’, or any combination thereof is increased and when the wavelength of the sound is decreased.

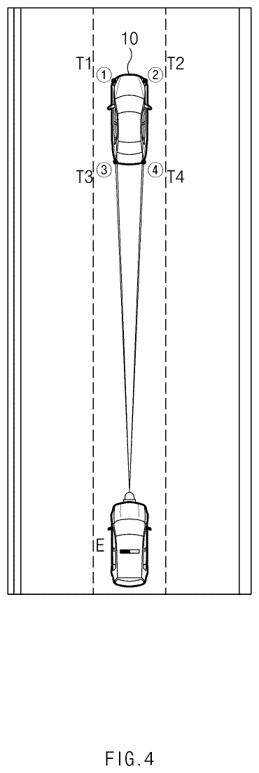

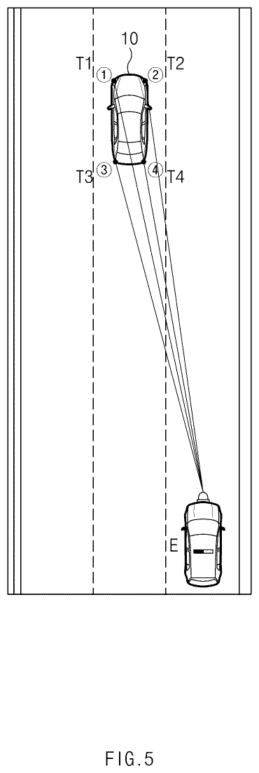

FIGS. 4 and 5 are views schematically illustrating a manner of determining a position of an emergency vehicle, according to an embodiment of the present disclosure.

As illustrated in FIG. 4, the processor 160 may determine that the emergency vehicle is driving on a lane the same as the driving lane on which the host vehicle is driving when the difference between the time (T1) for the sound of the emergency vehicle E to reach the first sensor ‘\textcircled{1}’ of the host vehicle 10 and the time (T2) for the sound of the emergency vehicle E to reach the second sensor ‘\textcircled{2}’ of the host vehicle 10 is less than or equal to a first specific value, and the difference between the time (T3) for the sound of the emergency vehicle E to reach the third sensor ‘\textcircled{3}’ of the host vehicle 10 and the time (T4) for the sound of the emergency vehicle E to reach the fourth sensor ‘\textcircled{4}’ of the host vehicle 10 is less than or equal to the first specific value.

As illustrated in FIG. 5, the processor 160 may determine that the emergency vehicle is driving on a lane different from the driving lane on which the host vehicle is driving when the difference between the time (T1) for the sound of the emergency vehicle E to reach the first sensor ‘\textcircled{1}’ of the host vehicle 10 and the time (T2) for the sound of the emergency vehicle E to reach the second sensor ‘\textcircled{2}’ of the host vehicle 10 exceeds the first specific value, and when the difference between the time (T3) for the sound of the emergency vehicle E to reach the third sensor ‘\textcircled{3}’ of the host vehicle 10 and the time (T4) for the sound of the emergency vehicle E to reach the fourth sensor ‘\textcircled{4}’ of the host vehicle 10 exceeds the first specific value.

For example, the processor 160 may determine that the emergency vehicle is driving on a lane at a right side of the host vehicle when the difference between the time (T1) for the sound of the emergency vehicle E to reach the first sensor ‘\textcircled{1}’ of the host vehicle 10 and the time (T2) for the sound of the emergency vehicle E to reach the second sensor ‘\textcircled{2}’ of the host vehicle 10 exceeds the first specific value, and when the difference between the time (T3) for the sound of the emergency vehicle E to reach the third sensor ‘\textcircled{3}’ of the host vehicle 10 and the time (T4) for the sound of the emergency vehicle E to reach the fourth sensor ‘\textcircled{4}’ of the host vehicle 10 exceeds the first specific value.

Alternatively, the processor 160 may determine that the emergency vehicle is driving on a lane at a left side of the host vehicle when the difference between the time (T2) for the sound of the emergency vehicle E to reach the first sensor ‘\textcircled{1}’ of the host vehicle 10 and the time (T1) for the sound of the emergency vehicle E to reach the second sensor ‘\textcircled{2}’ of the host vehicle 10 exceeds the first specific value, and when the difference between the time (T4) for the sound of the emergency vehicle E to reach the third sensor ‘\textcircled{3}’ of the host vehicle 10 and the time (T3) for the sound of the emergency vehicle E to reach the fourth sensor ‘\textcircled{4}’ of the host vehicle 10 exceeds the first specific value.

The processor 160 may determine the moving path of the emergency vehicle based on the driving state of the emergency vehicle, when the driving state of the emergency vehicle is determined, and may control the host vehicle to avoid the moving path of the emergency vehicle.

According to an embodiment, the processor 160 may control the driving of the host vehicle 10 such that a moving passage for the emergency vehicle is formed based on the driving state of the emergency vehicle by activating a driving assist function. The driving assist function may include the function (e.g., a function of controlling the driving of the host vehicle to a front portion, a rear portion, or a left or right portion of the host vehicle to keep a lane of the host vehicle or of changing the lane of the host vehicle of an Automated Lane Keeping System (ALKS)

For example, the processor 160 may control the driving of the host vehicle to form the moving passage for the emergency vehicle when the processor 160 determines that the emergency vehicle is driving on the lane the same as the lane on which the host vehicle is driving and is approaching the host vehicle from the back of the host vehicle. According to an embodiment, the processor 160 may control the host vehicle to drive while biasing to one side of the driving lane on which the host vehicle is driving, or to perform a lane change to depart the driving lane to move into another lane, such that the moving passage of the emergency vehicle is formed. In addition, the processor 160 may output information on controlled driving through the output device 140.

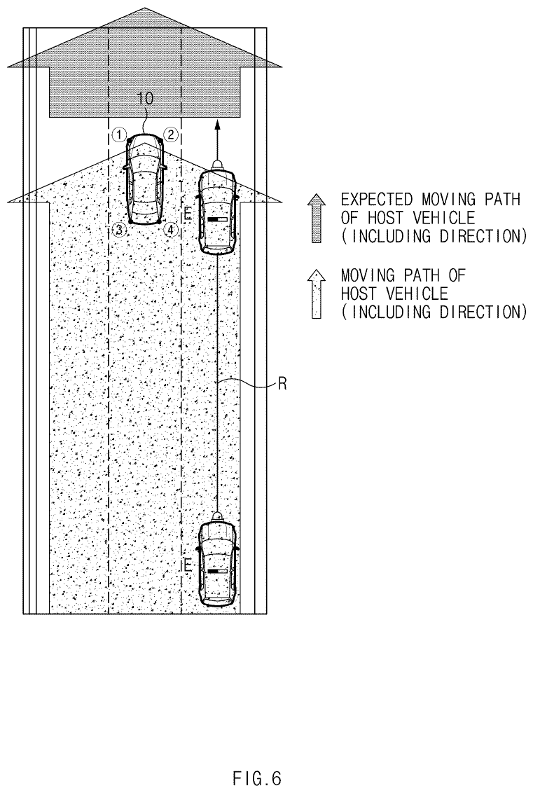

The processor 160 may determine that the determination of the driving state of the emergency vehicle has failed when the first sensor ‘\textcircled{1}’, the second sensor ‘\textcircled{2}’, the third sensor ‘\textcircled{3}’, or the fourth sensor ‘\textcircled{4}’ fails to sense at least one of the time required for the sound to reach the host vehicle, the change in the frequency of the sound, the change in the wavelength of the sound, or any combination thereof. In this case, the processor 160 may determine the driving state of the emergency vehicle according to another embodiment of the present disclosure. The details thereof, according to an embodiment, are described below with reference to FIGS. 6 to 10.

FIGS. 6 to 10 are views schematically illustrating a manner of determining a position of an emergency vehicle, according to another embodiment of the present disclosure.

As illustrated in FIGS. 6 to 8, the processor 160 may determine points at which the sound of the emergency vehicle E is generated based on a time for the sound of the emergency vehicle E to reach the sensor 110. The processor 160 may generate the moving path R of the sound by linking the points at which the sound of the emergency vehicle is generated to each other.

The processor 160 may determine that the emergency vehicle E is driving in the back of the host vehicle 10 when the time for the sound of the emergency vehicle E to reach a sensor (e.g., the first sensor ‘\textcircled{1}’ or the second sensor ‘\textcircled{2}’) positioned at the front portion of the host vehicle exceeds the time for the sound of the emergency vehicle E to reach a sensor (e.g., the third sensor ‘\textcircled{3}’ or the fourth sensor ‘\textcircled{4}’) positioned at the rear portion of the host vehicle. In addition, when determining that the emergency vehicle E is driving in the back of the host vehicle, the processor 160 may determine whether the moving path of the host vehicle 10 is the same as the moving path R of the sound. For example, the processor 160 may determine whether the moving path of the host vehicle 10 includes the moving path R of the sound, which is determined based on sound, and whether the direction of the moving path of the host vehicle 10 is the moving path R of the sound.

The processor 160 may determine that the emergency vehicle E is approaching the host vehicle 10 when the processor 160 determines that the moving path of the host vehicle 10 is the same as the moving path R of the sound.

The processor 160 may control the driving of the host vehicle 10 such that the moving passage of the emergency vehicle E is formed depending on whether the emergency vehicle E is positioned at a right lane or a left lane of the driving lane of the host vehicle 10, or a lane the same as the driving lane of the host vehicle 10 when the processor 160 determines that the emergency vehicle E is approaching the host vehicle 10.

According to an embodiment, as illustrated in FIG. 6, the processor 160 may control the driving of the host vehicle 10 such that the host vehicle 10 keeps the driving lane when the processor 160 determines that the emergency vehicle E is positioned on the right lane of the driving lane of the host vehicle 10. In this case, the processor 160 may control the driving of the host vehicle 10 such that the host vehicle 10 is biased to the left side of the driving lane to easily form the moving passage of the emergency vehicle E.

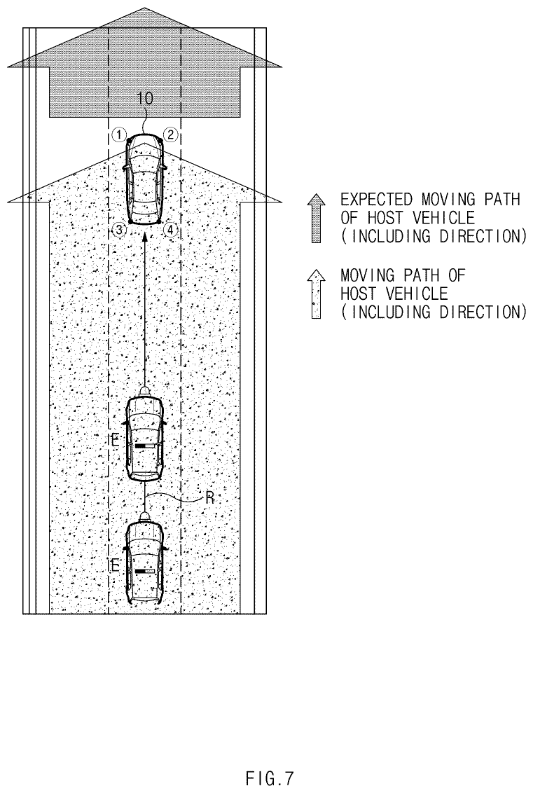

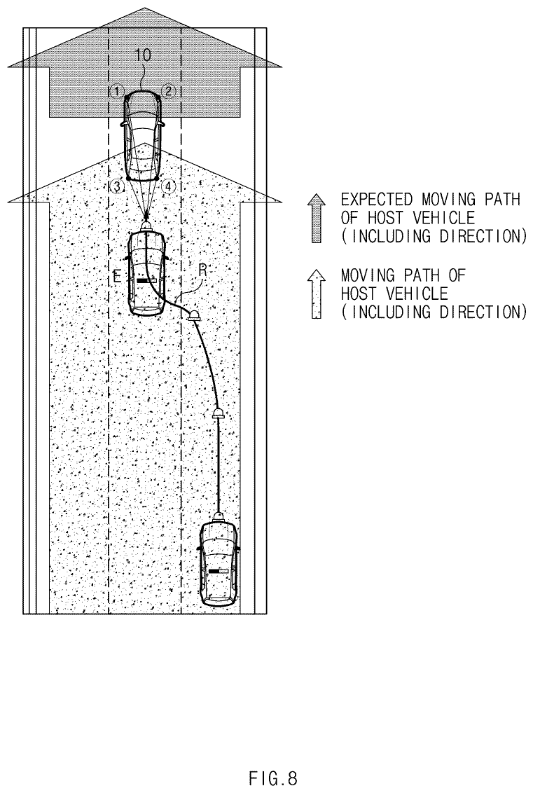

According to an embodiment, as illustrated in FIGS. 7 and 8, the processor 160 may control the host vehicle 10 to depart the driving lane, on which the host vehicle 10 is driving, and to change the lane to another lane, such that the moving passage of the emergency vehicle E is formed when the processor 160 determines that the emergency vehicle E is positioned in the back of the host vehicle 10 on the driving lane of the host vehicle or that the emergency vehicle E is approaching the rear portion 10 of the driving lane of the host vehicle 10. In addition, the processor 160 may output information on controlled driving through the output device 140.

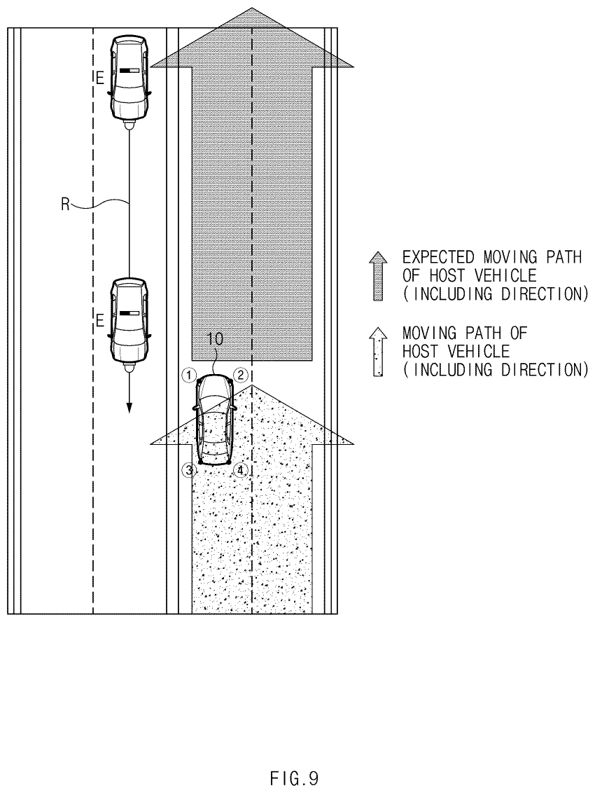

As illustrated in FIG. 9, the processor 160 may determine that the emergency vehicle E is not driving in the back of the host vehicle 10 when the time for the sound of the emergency vehicle E to reach a sensor (e.g., the first sensor ‘\textcircled{1}’ or the sensor ‘\textcircled{2}’) positioned in the front portion of the host vehicle 10 does not exceed the time for the sound of the emergency vehicle E to reach a sensor (e.g., the third sensor ‘\textcircled{3}’ or the fourth sensor ‘\textcircled{4}’) positioned in the rear portion of the host vehicle 10. When the processor 160 determines that the emergency vehicle E is not driving in the back of the host vehicle 10, the processor 160 may determine whether the moving path R of the sound is opposite to the moving path of the host vehicle 10 or the expected moving path of the host vehicle 10.

The processor 160 may determine whether a relative speed of the emergency vehicle E is greater than or equal to a threshold speed when the processor 160 determines that the moving path R of the sound is opposite to the moving path or the expected moving path of the host vehicle 10. In addition, the processor 160 may determine whether the position of the point at which the sound is generated is spaced apart in a transverse direction from the host vehicle 10 by a specific distance.

Generally, relative speed is increased when vehicles are driving in opposite directions, as compared when vehicles are driving in the same direction. Accordingly, when the processor 160 determines that the relative speed is greater than or equal to the threshold speed and that the position of the point at which the sound is generated is spaced apart in the transverse direction from the host vehicle by the specific distance, the processor 160 may determine that the emergency vehicle E is driving on a driving lane positioned in a direction opposite to the driving direction of the host vehicle 10.

The processor 160 may filter out the emergency vehicle E that is driving on the driving lane positioned in the direction opposite to the driving direction of the host vehicle 10 when controlling the driving of the host vehicle 10. For example, controlling the driving of the host vehicle 10 may not be needed for forming the moving passage of the emergency vehicle E when the emergency vehicle E is driving on the driving lane positioned in the direction opposite to the driving direction of the host vehicle 10.

According to an embodiment, the processor 160 may erroneously determine that the emergency vehicle E is driving on the driving lane positioned in the direction opposite to the driving direction of the host vehicle 10, even when the speed of the host vehicle 10 is greater than the speed of the emergency vehicle E. In this case, the processor 160 may determine the driving direction of the emergency vehicle E based on the relative speed of the emergency vehicle E.

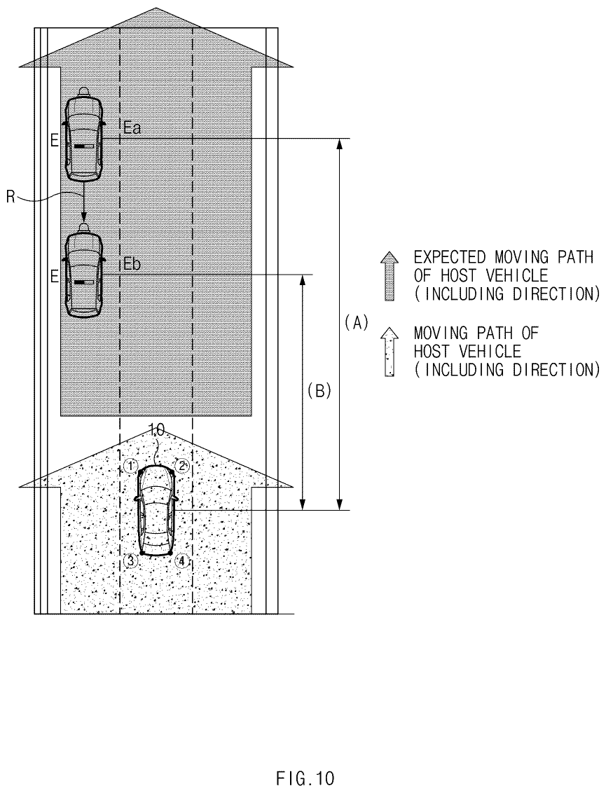

The processor 160 may determine that the emergency vehicle E and the host vehicle 10 are driving in the same direction when the processor 160 determines that the relative speed is not greater than or equal to the threshold speed. On the other hand, the processor 160 may determine that the host vehicle 10 is driving while approaching the emergency vehicle E in the back of the emergency vehicle E. The details thereof, according to an embodiment, are described below with reference to FIG. 10. As illustrated in FIG. 10, the processor 160 may determine

that the emergency vehicle E is not driving in the back of the host vehicle 10 when the time for the sound of the emergency vehicle E to reach a sensor (e.g., the first sensor ‘\textcircled{1}’ or the second sensor ‘\textcircled{2}’) positioned at the front portion of the host vehicle 10 does not exceed the time for the sound of the emergency vehicle E to a sensor (e.g., the third sensor ‘\textcircled{3}’ or the fourth sensor ‘\textcircled{4}’) positioned at the rear portion of the host vehicle 10. In addition, the processor 160 may determine that the moving path R of the sound is opposite to the moving path of the host vehicle 10 or the expected moving path of the host vehicle 10 when the processor 160 determines that the emergency vehicle E is not driving in the back of the host vehicle 10.

The processor 160 may determine that the moving path R of the sound is opposite to the moving path of the host vehicle or the expected moving path of the host vehicle 10 when a relative distance ‘B’ between the emergency vehicle E and the host vehicle 10 after the specific time is shorter than an initial relative distance ‘A’ between the emergency vehicle E and the host vehicle 10.

The processor 160 may determine whether a relative speed of the emergency vehicle E is greater than or equal to a threshold speed when the processor 160 determines that the moving path R of the sound is opposite to the moving path or the expected moving path of the host vehicle 10. In addition, the processor 160 may determine whether the position of the point at which the sound is generated is spaced apart in the transverse direction from the host vehicle 10 by the specific distance.

The processor 160 may determine that the emergency vehicle E is driving in a direction the same as the driving direction of the host vehicle 10 and that the host vehicle 10 is driving while approaching the emergency vehicle E in the back of the emergency vehicle E when the relative speed is not greater than or equal to than the threshold speed (i.e., when the relative speed is less than the threshold speed), and when the position of the point at which the sound is generated is not spaced apart in the transverse direction from the host vehicle by a specific distance.

According to an embodiment, the processor 160 may determine the moving path of the emergency vehicle E based on the driving state of the emergency vehicle E and may activate a driving assist function. According to an embodiment, the processor 160 may control the driving of the host vehicle 10 to avoid the moving path of the emergency vehicle E.

According to an embodiment, the processor 160 may activate the driving assist function to basically block the host vehicle 10 from interrupting the driving of the emergency vehicle E in the back of the emergency vehicle E based on the driving state of the emergency vehicle E. According to an embodiment, when the processor determines that the host vehicle 10 is approaching the emergency vehicle E and is driving at a speed higher than that of the emergency vehicle E, the processor 160 may control the host vehicle 10 to drive at the same speed as that of the emergency vehicle E or to decelerate more than the emergency vehicle E. Alternatively, when the processor 160 determines that the host vehicle 10 is driving at a speed higher than that of the emergency vehicle E on the same lane as that of the emergency vehicle E, the processor 160 may control the host vehicle 10 to change the lane and to drive on a lane different from the driving lane of the emergency vehicle E, thereby preventing the driving of the emergency vehicle E from being interrupted.

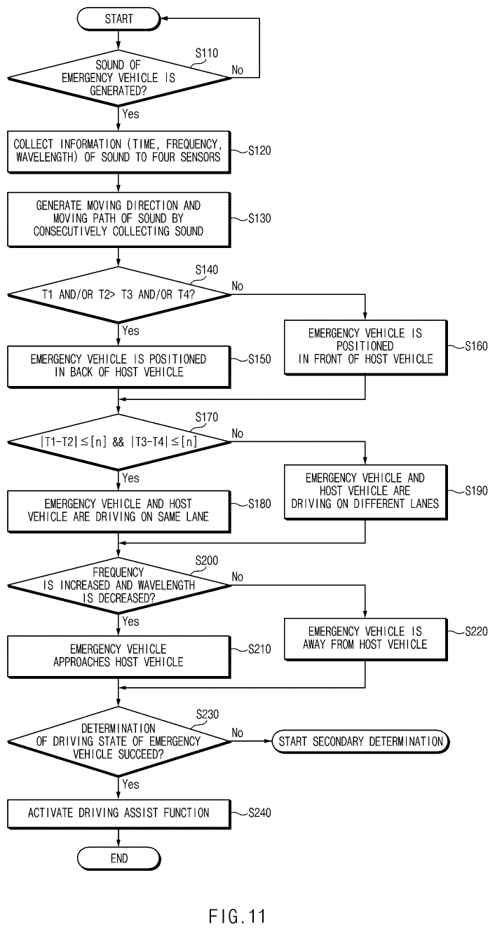

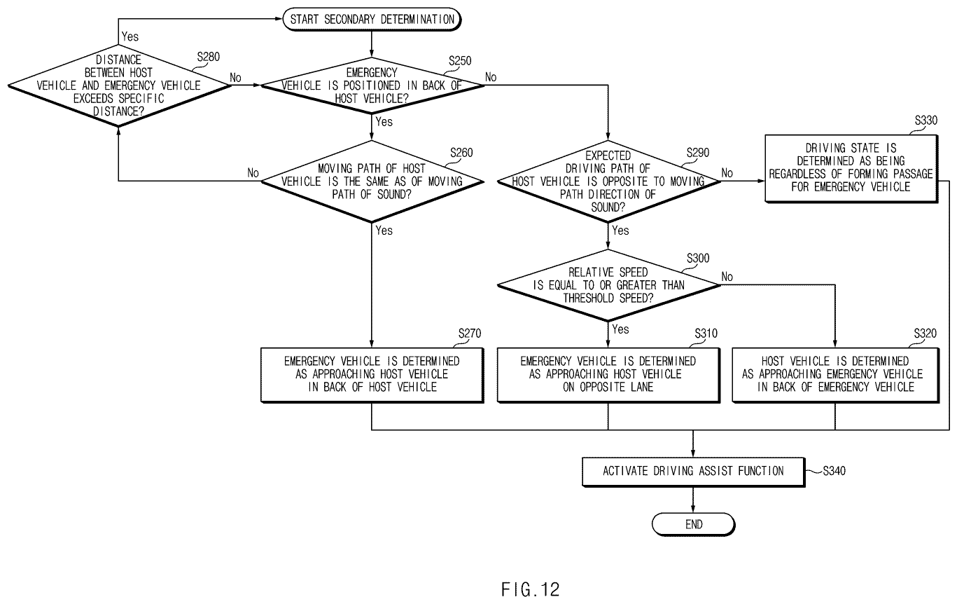

FIGS. 11 and 12 are flowcharts illustrating a method for controlling a vehicle, according to an embodiment of the present disclosure.

As illustrated in FIG. 11, in an operation S110, the processor 160 may determine whether the sound of the emergency vehicle E is generated.

In an operation S120, the processor 160 may acquire the time, the wavelength, and/or the frequency for the sound of the emergency vehicle E to reach the first sensor ‘\textcircled{1}’, the second sensor ‘\textcircled{2}’, the third sensor ‘\textcircled{3}’, and/or the fourth sensor.

In an operation S130, the processor 160 may determine a point at which the sound of the emergency vehicle E is generated based on the time, the wavelength, or the frequency for the sound of the emergency vehicle E to reach the first sensor ‘\textcircled{1}’, the second sensor ‘\textcircled{2}’, the third sensor ‘\textcircled{3}’, and/or the fourth sensor as the sound is consecutively acquired (e.g., collected) in a specific period. The processor 160 may also determine the moving direction of the sound and the moving path R of the sound by linking, to each other, the points at which sounds of the emergency vehicle E are generated.

In an operation S140, the processor 160 may determine whether the time for the sound of the emergency vehicle E to reach at least one of the first sensor ‘\textcircled{1}’, the second sensor ‘\textcircled{2}’, or any combination thereof exceeds the time for the sound of the emergency vehicle E to reach at least one of the third sensor ‘\textcircled{3}’, the fourth sensor ‘\textcircled{4}’, or any combination thereof.

When it is determined in the operation S140 that the time for the sound of the emergency vehicle E to reach at least one of the first sensor ‘\textcircled{1}’, the second sensor ‘\textcircled{2}’, or any combination thereof exceeds the time for the sound of the emergency vehicle E to reach at least one of the third sensor ‘\textcircled{3}’, the fourth sensor ‘\textcircled{4}’, or any combination thereof, the processor 160 may, in an operation S150, determine that the emergency vehicle is driving in the back of the host vehicle.

On the other hand, when it is determined in the operation S140 that the time for the sound of the emergency vehicle E to reach at least one of the first sensor ‘\textcircled{1}’, the second sensor ‘\textcircled{2}’, or any combination thereof does not exceed the time for the sound of the emergency vehicle E to reach at least one of the third sensor ‘\textcircled{3}’, the fourth sensor ‘\textcircled{4}’, or any combination thereof, the processor 160 may, in an operation S160, determine that the emergency vehicle is driving in front of the host vehicle.

In an operation S170, the processor 160 may determine whether i) the difference between the time (T1) for the sound of the emergency vehicle E to reach the first sensor ‘\textcircled{1}’ of the host vehicle 10 and the time (T2) for the sound of the emergency vehicle E to reach the second sensor ‘\textcircled{2}’ of the host vehicle 10 is less than or equal to a first specific value and ii) the difference between the time (T3) for the sound of the emergency vehicle E to reach the third sensor ‘\textcircled{3}’ of the host vehicle 10 and the time (T4) for the sound of the emergency vehicle E to reach the fourth sensor ‘\textcircled{4}’ of the host vehicle 10 is less than or equal to the first specific value.

When it is determined in the operation S170 that i) the difference between the time (T1) for the sound of the emergency vehicle E to reach the first sensor ‘\textcircled{1}’ of the host vehicle 10 and the time (T2) for the sound of the emergency vehicle E to reach the second sensor ‘\textcircled{2}’ of the host vehicle 1 is less than or equal to the first specific value and ii) the difference between the time (T3) for the sound of the emergency vehicle E to reach the third sensor ‘\textcircled{3}’ of the host vehicle 10 and the time (T4) for the sound of the emergency vehicle E to reach the fourth sensor (4)′ of the host vehicle 10 is less than or equal to the first specific value, the processor 160 may, in an operation S180, determine that the emergency vehicle is driving on a lane the same as a lane on which the host vehicle is driving.

On the other hand, when it is determined in the operation S170 that i) the difference between the time (T1) for the sound of the emergency vehicle E to reach the first sensor ‘\textcircled{1}’ of the host vehicle 10 and the time (T2) for the sound of the emergency vehicle E to reach the second sensor ‘\textcircled{2}’ of the host vehicle 10 is less than or equal to the first specific value and ii) the difference between the time (T3) for the sound of the emergency vehicle E to reach the third sensor ‘\textcircled{3}’ of the host vehicle 10 and the time (T4) for the sound of the emergency vehicle E to reach the fourth sensor ‘\textcircled{4}’ of the host vehicle 10 exceeds the first specific value, the processor 160 may, in an operation S190, determine that the emergency vehicle is driving on a lane different from a lane on which the host vehicle is driving.

In an operation S200, the processor 160 may determine whether i) the strength of the frequency of the sound acquired by at least one of the first sensor ‘\textcircled{1}’, the second sensor ‘\textcircled{2}’, the third sensor ‘\textcircled{3}’, the fourth sensor ‘\textcircled{4}’, or any combination thereof is increased and ii) the wavelength of the sound is decreased.

When it is determined in the operation S200 that i) the strength of the frequency of the sound acquired by at least one of the first sensor ‘\textcircled{1}’, the second sensor ‘\textcircled{2}’, the third sensor ‘\textcircled{3}’, the fourth sensor 4′, or any combination thereof is increased and ii) the wavelength of the sound is decreased, the processor 160 may, in an operation S210, determine that the emergency vehicle is driving while approaching the host vehicle.

On the other hand, when it is determined in the operation S200 that i) the strength of the frequency of the sound acquired by at least one of the first sensor ‘\textcircled{1}’, the second sensor ‘\textcircled{2}’, the third sensor ‘\textcircled{3}’, the fourth sensor ‘\textcircled{4}’, or any combination thereof is decreased and ii) the wavelength of the sound is increased, the processor 160 may, in an operation S220, determine that the emergency vehicle is driving away from the host vehicle.

In an operation S230, the processor 160 may determine whether the determination in the driving state of the emergency vehicle has succeeded.

In the operation S230, the processor 160 may determine that the determination of the driving state of the emergency vehicle has failed when the first sensor ‘\textcircled{1}’, the second sensor ‘\textcircled{2}’, the third sensor ‘\textcircled{3}’, or the fourth sensor ‘\textcircled{4}’ fails to sense at least one of the time required for the sound to reach the host vehicle, the change in the frequency of the sound, the change in the wavelength of the sound, or any combination thereof. In this case, the processor 160 may determine the driving state of the emergency vehicle according to another embodiment of the present disclosure. The details thereof, according to an embodiment, are described below with reference to FIG. 12.

In the operation S230, the processor 160 may also determine the moving path of the emergency vehicle E based on the driving state of the emergency vehicle and may, in an operation S240, activate the driving assist function, when successfully determining the driving state of the emergency vehicle. According to an embodiment, the processor 160 may control the driving of the host vehicle to avoid the moving path of the emergency vehicle E.

According to an embodiment, the processor 160 may control the driving of the host vehicle 10 to form the moving passage for the emergency vehicle E by activating the driving assist function based on the driving state of the emergency vehicle E. According to an embodiment, the processor 160 may control the host vehicle to drive while biasing to one side of the lane (driving lane) on which the host vehicle is driving, or to perform a lane change to depart the driving lane to move into another lane, when the emergency vehicle is driving on the lane on which the host vehicle is driving. In addition, the processor 160 may output information on controlled driving through the output device 140.

Referring now to FIG. 12, in an operation S250, the processor 160 may determine whether the emergency vehicle is positioned at the rear portion of the host vehicle.

When it is determined in the operation S250 that the emergency vehicle is positioned in the back of the host vehicle, the processor 160 may, in an operation S260, determine whether the moving path of the host vehicle is the same as the moving path of the sound. For example, the processor 160 may determine whether the moving path of the host vehicle includes the moving path of the sound, which is determined based on a sound, and whether the direction of the moving path of the host vehicle is the moving path of the sound.

When it is determined in the operation S260 that the moving path of the host vehicle 10 is the same as the moving path R of the sound, the processor 160 may, in an operation S270, determine that the emergency vehicle E is driving while approaching the host vehicle 10 in back of the host vehicle.

In an operation S340, the processor 160 may determine the driving assist function based on the driving state of the emergency vehicle, when it is determined that the emergency vehicle is driving while approaching the host vehicle in back of the host vehicle 10. According to an embodiment, the processor 160 may control the host vehicle to perform a lane change to depart the driving lane to move into another lane such that the moving passage of the emergency vehicle is formed.

On the other hand, when it is determined in the operation S260 that the moving path of the host vehicle is not the same as the moving path of the sound, the processor 160 may, in an operation S280, determine whether the distance between the emergency vehicle and the host vehicle exceeds a specific distance.

When it is determined that the emergency vehicle is positioned in back of the host vehicle while exceeding the specific distance and the distance between the emergency vehicle and the host vehicle does not exceed the specific distance, the processor 160 may determine the driving state of the emergency vehicle E again. In addition, when it is determined that the emergency vehicle E does not exceed the specific distance, the processor 160 may, in the operation S250, determine whether the emergency vehicle E is positioned in back of the host vehicle 10.

When it is determined in the operation S250 that the emergency vehicle is not positioned in back of the host vehicle, the processor 160 may, in an operation S290, determine whether the moving path of the sound is opposite to the moving path of the host vehicle or the expected moving path of the host vehicle.

When it is determined in the operation S290 that the moving path of the sound is opposite to the moving path or the expected moving path of the host vehicle 10, the processor 160 may, in an operation S300, determine whether a relative speed of the emergency vehicle is greater than or equal to the threshold speed. In addition, the processor 160 may determine whether the position of the point at which the sound is generated is spaced apart in the transverse direction from the host vehicle 10 by a specific distance.

Generally, the relative speed is increased in driving in the opposite directions, as compared to the driving in the same direction. Accordingly, when it is determined that the relative speed is greater than or equal to the threshold speed and that the position of the point at which the sound is generated is spaced apart in the transverse direction from the host vehicle by the specific distance, the processor 160 may, in an operation S310, determine that the emergency vehicle E is driving on a driving lane positioned in a direction opposite to the driving direction of the host vehicle.

The processor 160 may filter out an emergency vehicle driving on a driving lane facing a direction opposite to the driving direction of the host vehicle, in controlling driving of the host vehicle, when it is determined that the emergency vehicle is driving on the driving lane facing the opposite direction to the driving direction of the host vehicle, when it is determined controlling the driving of the host vehicle is not needed to form the moving path of the emergency vehicle, and/or when activating the driving assist function of the host vehicle.

When it is determined in the operation S300 that the relative speed is not greater than or equal to the threshold speed, the processor 160 may, in an operation S320, determine that the emergency vehicle E and the host vehicle are driving in the same direction, and may determine that the emergency vehicle E is driving while approaching in back of the host vehicle 10.

In an operation S340, the processor 160 may determine the moving path of the emergency vehicle based on the driving state of the emergency vehicle and activate the driving assist function when it is determined that the host vehicle is driving while approaching in the back of the emergency vehicle. According to an embodiment, the processor 160 may control the host vehicle to avoid the moving path of the emergency vehicle.

In the operation S340, the processor 160 may activate the driving assist function to basically block the host vehicle 10 from interrupting the driving of the emergency vehicle E in back of the emergency vehicle. According to an embodiment, the processor 160 may control the host vehicle to drive at a speed the same as that of the emergency vehicle E or to decelerate more than that of the emergency vehicle when it is determined that the host vehicle 10 is driving at a speed higher than that of the emergency vehicle E while approaching the host vehicle 10. The processor 160 may control the host vehicle 10 to drive on the lane different from the driving lane of the emergency vehicle E by controlling the lane change when it is determined that the host vehicle is driving at a speed higher than that of the emergency vehicle E on the same lane as that of the host vehicle such that the driving of the emergency vehicle E is not interrupted.

In an operation S330, the processor 160 may determine that the host vehicle 10 does not interrupt the driving of the emergency vehicle E while the emergency vehicle E is driving in front of the host vehicle when it is determined in the operation S290 that the moving path of the sound is not opposite to the moving path of the host vehicle or the expected moving path of the host vehicle.

In this state, the processor 160 may filter out the emergency vehicle such that the emergency vehicle is not considered in controlling the driving of the host vehicle 10, when activating the driving assist function in the operation S340.

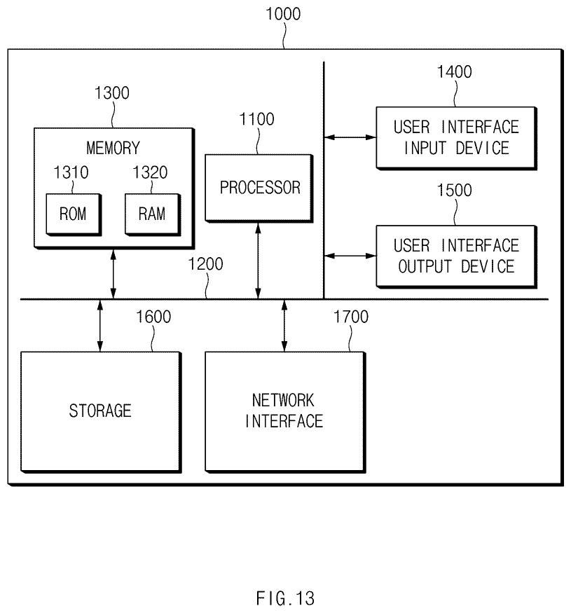

FIG. 13 is a view illustrating the configuration of a computing system that may execute the method of FIGS. 11 and 12, according to an embodiment of the present disclosure.

Referring to FIG. 13, a computing system 1000 may include at least one processor 1100, a memory 1300, a user interface input device 1400, a user interface output device 1500, a storage 1600, and a network interface 1700, which may be connected with each other via a system bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only ROM 1310 and a RAM 1320.

Thus, the operations of the methods or algorithms described in connection with the embodiments disclosed in the present disclosure may be directly implemented with a hardware module, a software module, or any combination thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. Alternatively, the storage medium may be at least partially integrated with the processor 1100. The processor 1100 may read out information from the storage medium and may write information in the storage medium. The processor and storage medium may reside in an application specific integrated circuit (ASIC). The ASIC may reside in a user terminal. Alternatively, the processor and storage medium may reside as separate components of the user terminal.

According to an embodiment of the present disclosure, in the apparatus and method for controlling a host vehicle, the position of an emergency vehicle is quickly determined using the sound output from the emergency vehicle and the driving path (or of the host vehicle, thereby the expected driving path) effectively using an automated lane keeping function.

According to an embodiment of the present disclosure, in the apparatus and the method for controlling the host vehicle, the relationship between the moving path of the emergency vehicle and the moving path of the host vehicle may be determined based on the position of the emergency vehicle determined using the sound output from the emergency vehicle and the driving path (or expected driving path) of the host vehicle.

According to an embodiment of the present disclosure, in the apparatus and the method for controlling the host vehicle, unnecessary information when generating the moving passage of the emergency vehicle may be filtered based on a moving path of a host vehicle and a moving path of the emergency vehicle.

According to an embodiment of the present disclosure, in the apparatus and the method for controlling the host vehicle, the moving path of the emergency vehicle may be easily formed by allowing lane departure in advance, as the moving path of the emergency vehicle is determined using the sound output from the emergency vehicle and the driving path (or expected driving path) of the host vehicle.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

Therefore, the embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for controlling a host vehicle, the apparatus comprising:
a sensor configured to acquire a sound of another vehicle;
a position acquiring device configured to acquire a moving path and an expected moving path of the host vehicle;
one or more processors; and
a memory configured to store instructions that, when executed by the one or more processors, cause the one or more processors to:
determine a driving state of the other vehicle based on at least one of the sound of the other vehicle, the moving path, or the expected moving path, or any combination thereof,
determine a moving path of the other vehicle based on a driving state of the other vehicle, and
control to avoid the moving path of the other vehicle.

2. The apparatus of claim 1, wherein the sensor includes:
a first sensor provided on a left side of a front portion of the host vehicle,
a second sensor provided on a right side of the front portion of the host vehicle,
a third sensor provided on a left side of a rear portion of the host vehicle, and
a fourth sensor provided on a right side of the rear portion of the host vehicle.

3. The apparatus of claim 2, wherein the one or more processors are configured to:
determine that the other vehicle is driving in back of the host vehicle when a time for the sound to reach at least one of the first sensor, the second sensor, or any combination thereof exceeds a time for the sound to reach at least one of the third sensor, the fourth sensor, or any combination thereof.

4. The apparatus of claim 2, wherein the one or more processors are configured to:
determine that the other vehicle is driving on a lane the same as a lane on which the host vehicle is driving, when i) a difference between a time for the sound to reach the first sensor and a time for the sound to reach the second sensor is less than or equal to a first specific value and ii) a difference between a time for the sound to reach the third sensor and a time for the sound to reach the fourth sensor is less than or equal to the first specific value.

5. The apparatus of claim 4, wherein the one or more processors are configured to:
determine that the other vehicle is driving on a lane different from a lane on which the host vehicle is driving when i) the difference between the time for the sound to reach the first sensor, and the time for the sound to reach the second sensor exceeds the first specific value and ii) the difference between the time for the sound to reach the third sensor and the time for the sound to reach the fourth sensor exceeds the first specific value.

6. The apparatus of claim 2, wherein the one or more processors are configured to:
determine that the other vehicle is driving while approaching the host vehicle when i) a frequency of a sound acquired by at least one of the first sensor, the second sensor, the third sensor, or the fourth sensor, or any combination thereof, is increased in strength and ii) a wavelength of the sound is decreased.

7. The apparatus of claim 2, wherein the one or more processors are configured to:
determine that determination of a driving state of the other vehicle has failed when failing to sense at least one of a time for the sound to reach at least one of the first sensor, the second sensor, the third sensor, or the fourth sensor, or any combination thereof, a variation of a frequency of the sound, a variation of a wavelength of the sound, or any combination thereof.

8. The apparatus of claim 7, wherein the one or more processors are configured to:
determine the driving state of the other vehicle based on i) at least one of the expected moving path of the host vehicle, the moving path of the host vehicle, or any combination thereof and ii) a moving path of the sound, wherein the moving path of the sound is formed based on the sound, when it is determined that the determination of the driving state of the other vehicle has failed.

9. The apparatus of claim 8, wherein the one or more processors are configured to:
determine whether the moving path of the host vehicle is the same as the moving path of the sound when it is determined that the other vehicle is driving in back of the host vehicle.

10. The apparatus of claim 9, wherein the one or more processors are configured to:
determine that the other vehicle is driving while approaching the host vehicle when it is determined that the moving path of the host vehicle is the same as the moving path of the sound.

11. The apparatus of claim 9, wherein the one or more processors are configured to:
determine whether the moving path of the host vehicle is opposite to the moving path of the sound when it is determined that the other vehicle is not driving in back of the host vehicle.

12. The apparatus of claim 11, wherein the one or more processors are configured to:
determine whether relative speed of the other vehicle is greater than or equal to a threshold speed when it is determined that the moving path of the host vehicle is opposite to the moving path of the sound.

13. The apparatus of claim 12, wherein the one or more processors are configured to:
determine that the other vehicle is driving on a driving lane facing a direction opposite to a driving direction of the host vehicle when the relative speed of the other vehicle is greater than or equal to the threshold speed.

14. The apparatus of claim 12, wherein the one or more processors are configured to:
determine that the host vehicle is driving while approaching the other vehicle in back of the other vehicle when it is determined that the relative speed of the other vehicle is not greater than or equal to the threshold speed.

15. The apparatus of claim 1, wherein the one or more processors are configured to:
control driving of the host vehicle to form a moving passage for the other vehicle, based on the driving state of the other vehicle, by activating a driving assist function of the host vehicle.

16. The apparatus of claim 1, wherein the other vehicle comprises an emergency vehicle.

17. A method for controlling a host vehicle, the method comprising:
acquiring a sound of another vehicle;
acquiring a moving path and an expected moving path of the host vehicle;
determining a driving state of the other vehicle based on at least one of the sound of the other vehicle, the moving path, or the expected moving path, or any combination thereof;
determining the moving path of the other vehicle based on the driving state of the other vehicle; and
controlling the host vehicle to avoid the moving path of the other vehicle.

18. The method of claim 17, further comprising:
controlling driving of the host vehicle to form a moving passage for moving the other vehicle based on a driving state of the other vehicle by activating a driving assist function of the host vehicle.

19. The method of claim 17, wherein the other vehicle comprises an emergency vehicle.
